(19) United States
(12) Patent Application Publication
(10) Pub. No.: US 2010/0179731 A1
(43) Pub. Date: Jul. 15, 2010

(54) SYSTEM AND METHOD FOR PERFORMING VEHICLE SIDE IMPACT SENSING WITH UNIT AREA IMPULSE TECHNIQUE

(75) Inventors: Jialiang Le, Canton, MI (US); Todd Clark, Dearborn, MI (US); Manoharprasad K. Rao, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/354,183

(22) Filed: Jan. 15, 2009

(51) Int. Cl. G06F 17/00; B60R 21/16

(52) U.S. Cl. 701/47; 280/735

(57) ABSTRACT

A system for detecting impact events for a vehicle is provided. The system comprises a pressure sensor and a controller. The pressure sensor is positioned in a first impact zone of the vehicle and is configured to generate a pressure signal corresponding to a measured pressure reading within the first impact zone. The controller is positioned within the vehicle and is configured to integrate the pressure signal over time to determine the occurrence of a vehicle impact event at the first impact zone.

### BACKGROUND

1. Technical Field

One or more embodiments of the present invention described herein generally relate to a system and method for performing vehicle side impact sensing with unit area impulse.

2. Background Art

The use of pressure sensors for detecting vehicle side impacts have been known for several years. In general, the pressure sensors are positioned within door cavities (i.e., between A and B pillars) of a vehicle. The vehicle is generally equipped with a controller that includes a pressure threshold stored therein. The controller monitors pressure signals transmitted from one or more of the pressure sensors to determine if such signals exceed the pressure threshold. If the measured pressure signals exceed the pressure threshold, such a condition may correspond to the vehicle experiencing a side impact. While pressure sensor technology has proven to be effective in detecting vehicle side impacts under certain conditions, the pressure value used to define the pressure threshold may trigger a false detection of a vehicle side impact.

### SUMMARY

A system for detecting impact events for a vehicle is provided. The system comprises a pressure sensor and a controller. The pressure sensor is positioned in a first impact zone of the vehicle and is configured to generate a pressure signal corresponding to a measured pressure reading within the first impact zone. The controller is positioned within the vehicle and is configured to integrate the pressure signal over time to determine the occurrence of a vehicle impact event at the first impact zone.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 illustrates a system for sensing side impacts of a vehicle in accordance to one embodiment of the present invention;

FIG. 2 illustrates a first plot depicting time with respect to pressure readings for crashes with various intensity levels;

FIG. 3 illustrates a second plot depicting time with respect to pressure readings for crashes with low intensity levels;

FIG. 4 illustrates a third plot depicting time with respect to pressure integral readings for crashes with low intensity levels in accordance to one embodiment of the present invention; and

FIG. 5 illustrates a method for sensing side impacts of a vehicle in accordance to one embodiment of the present invention.

### DETAILED DESCRIPTION

The embodiments of the present invention generally provide a controller being operably coupled to a plurality of pressure sensors for detecting the occurrence of a vehicle impact. The controller includes a pressure integral level threshold for comparison to integrated pressure signals to determine if a valid vehicle side impact has occurred. Prior to the controller comparing the integrated pressure signals to the pressure integral level threshold, the controller integrates pressure signals transmitted by the pressure sensors to generate the integrated pressure signals. The controller is also operably coupled to accelerometer sensors positioned about the vehicle. The controller monitors acceleration signals transmitted by the accelerometer sensors and compares such signals to at least one acceleration threshold to confirm that a vehicle impact has occurred while generating and comparing the integrated pressure signals to the pressure integral level threshold. In the event both the integrated pressure signals and the measured acceleration signals exceed the pressure integral level threshold and the acceleration threshold, respectively, the controller deploys one or more safety restraint systems within the vehicle.

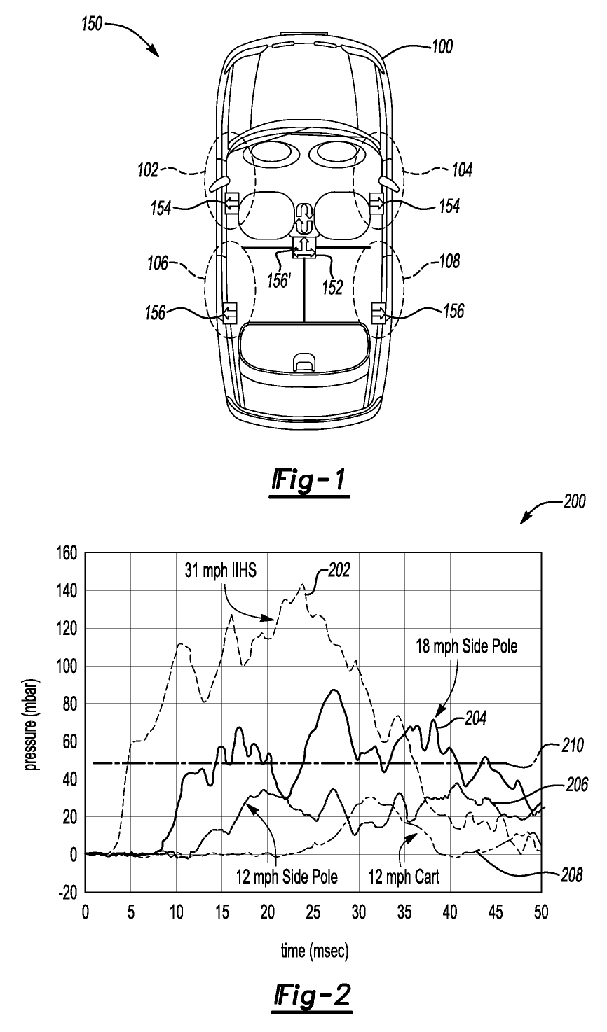

Referring now to FIG. 1, a system 150 for sensing side impacts of a vehicle 100 is shown in accordance to one embodiment of the present invention. The vehicle 100 may be divided into various side impact zones 102, 104, 106, 108. One or more of the side impact zones 102, 104, 106, and 108 may experience an impact from an on-coming object. Zone 102 generally includes a front driver section of the vehicle 100. Zone 104 generally includes a front passenger section of the vehicle 100. Zone 106 generally includes a rear driver section of the vehicle 100. Zone 108 generally includes a rear passenger section of the vehicle 100. The system 150 comprises a restraint controller 152, a plurality of pressure sensors 154, and a plurality of accelerometer sensors 156. The zones 102 and 104 each include a pressure sensor 154 positioned therein. The zones 106 and 108 each include an accelerometer sensor 156 positioned therein. In addition, the controller 152 also includes an accelerometer sensor 156′ positioned therein or about the controller 152. While FIG. 1 generally depicts that the pressure sensor 154 is positioned in zones 102 and 104, it is contemplated that the pressure sensor may be positioned in one or more of the zones 106 and 108 or at the front and/or rear of the vehicle 120.

In general, each pressure sensor 154 is positioned in a door well cavity of each zone 102 and 104 (or other suitable area in the vehicle). Each pressure sensor 154 is configured to measure pressure in each door cavity and to transmit a pressure signal corresponding to the measured amount of pressure for each door cavity in each corresponding zone 102 and 104 to the controller 152. The controller 152 monitors for pressure changes within each cavity of the zone 102 and 104 in response to the pressure signals transmitted from the pressure sensors 154 to determine whether the vehicle 100 is experiencing a side impact. In general, a pressure change in the door cavity of the vehicle 100 may be caused in response to the vehicle 100 experiencing a side impact. The controller 152 is configured to receive the pressure signals and to integrate the received pressure signals for comparison to at least one pressure integral level threshold to determine whether the vehicle has encountered a side impact. Prior to deploying one or more safety restraint systems in the vehicle 100 in the event the integrated pressure signals exceed the pressure integral level threshold, the controller 152 may validate the occurrence of a side impact at zones 102 and 104 by monitoring acceleration signals from the accelerometer sensors 156 and 156′.

Each accelerometer sensor 156 is coupled to a structural member positioned within each zone 106 and 108. Each accelerometer sensor 156 is configured to transmit a first acceleration signal to the controller 152. The first acceleration signal corresponds to the measured movement of the structural member(s) within zones 106 and 108 in the event the vehicle 100 experiences an impact. As noted above, the controller 152 also includes an accelerometer sensor 156′ positioned therein or about the controller 152. The accelerometer sensor 156′ generates a second acceleration signal that corresponds to the measured movement of structural member(s) about the center of the vehicle. The controller 152 monitors the first acceleration signals received by the accelerometer sensor 156 and the second acceleration signals received from the accelerometer sensor 156′ and compares such signals to at least one acceleration threshold to validate (or confirm) that the vehicle 100 has experienced a side impact. For example, the comparison of the acceleration signals to the acceleration threshold may serve as a mechanism to validate that a side impact collision has occurred at zones 102 and 104.

In general, the controller 152 integrates the pressure signals and compares such signals to the pressure integral level threshold and also receives the acceleration signals and compares such signals to the acceleration threshold to confirm that the vehicle 100 has encountered a side impact. In the event both the integrated pressure signals and the acceleration signals exceed the pressure integral level threshold and the acceleration threshold, respectively, the controller 152 controls various restraint systems to deploy. Such restraint systems may include, but are not limited to, curtain and/or side airbags (not shown).

Referring now to FIG. 2, a first plot 200 depicting time with respect to pressure readings that correspond to various crash intensity levels is shown. Waveform 202 corresponds to pressure readings (or pressure signals) that may be exhibited by pressure sensors with respect to time while the vehicle 100 is undergoing a 31 mph vehicle side impact test. Such a test may correspond to standards proscribed by the Insurance Institute for Highway Safety (IIHS). The 31 mph IIHS test is representative of high intensity level side impacts that may require side airbag and curtain airbag deployment.

Waveform 204 corresponds to pressure readings (or pressure signals) that may be exhibited by the pressure sensors with respect to time while the vehicle 100 is undergoing an 18 mph perpendicular pole (PP) vehicle side impact test. The 18 mph PP test is representative of medium intensity level side impacts that may also require side airbag and curtain airbag deployment. Waveform 206 corresponds to pressure readings (or pressure signals) that may be exhibited by the pressure sensors with respect to time while the vehicle 100 is undergoing a 12 mph PP vehicle side impact test. The 12 mph PP test is representative of low intensity level side impacts that may require side airbag and curtain airbag deployment. Waveform 208 corresponds to pressure readings (pressure signals) that may be exhibited by the pressure sensor with respect to time while the vehicle 100 is undergoing a 12 mph side impact Cart test. The 12 mph side impact CART test may be performed with a NHTSA side impactor with a moving deformable barrier traveling at 12 mph and at an angle of roughly 27 degrees with respect to the side of the vehicle. It is generally not desired to deploy restraints when such a test is performed.

Line 210 corresponds to a first pressure threshold (e.g., 50 mbar) that may be used to distinguish between side and curtain airbag deployment and non-deployment events during a side impact event. The use of 50 mbar for the first pressure threshold serves as an example and it is recognized that the first pressure threshold may be set to any pressure value as needed based on the desired criteria of a particular implementation. As exhibited in FIG. 2, the line 210 (or first pressure threshold) is appropriately set or defined such that the pressure readings corresponding to the waveforms 202 and 204 (e.g., the 31 mph IIHS and the 18 mph PP—high and medium level severity side impact tests, respectively) that exceed the line 210 may cause a deployable event. However, the waveform 208 may not exceed the first pressure threshold (e.g., line 210) thereby not causing the vehicle to deploy the side and curtain airbags under conditions corresponding to the 12 mph side pole impact.

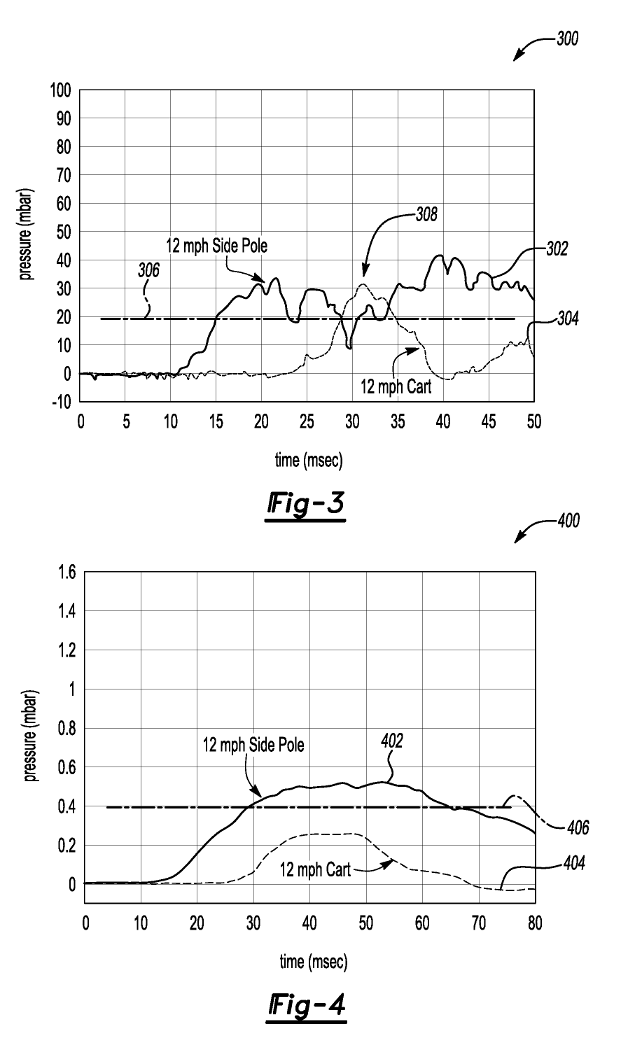

Referring now to FIG. 3, a second plot 300 depicting time with respect to pressure readings for crashes from the pressure sensors that correspond to low intensity levels crashes is shown. Waveform 302 corresponds to pressure readings (or pressure signals) that may be exhibited by the pressure sensor with respect to time while the vehicle 100 is undergoing a 12 mph (PP) vehicle side impact test. Waveform 302 is similar to waveform 206 of FIG. 2.

Waveform 304 corresponds to pressure readings (or pressure signals) that may be exhibited with respect to time by the pressure sensor 154 while the vehicle 100 is undergoing a 12 mph Cart test. Waveform 304 is similar to waveform 208 of FIG. 2. As noted above, it is generally not desired to deploy restraints when the 12 mph Cart test is performed. Line 306 may correspond to a second pressure level threshold (e.g., 20 mbar) that is needed to be exceeded in order to deploy restraints in the vehicle 100 for the 12 mph PP test. Such a condition may result in the 12 mph side pole test as represented by the waveform 302 and other high and medium intensity level side impact events deploying side airbags and curtain airbags as desired. However, at 308, various pressure readings within the waveform 304 exceed the second pressure level threshold which is indicative of a deploy event occurring. However, the pressure readings within 308 are part of the waveform 304 which correspond to the 12 mph Cart test. As noted above, the 12 mph Cart test generally represents a non-deployable condition. The pressure readings within 308 may cause the controller 152 to deploy restraints in the vehicle 100 thereby causing a faulty deploy condition. As noted with respect to the waveforms of FIGS. 2 and 3, it may be difficult to separate such deploy and non-deploy events during a side impact by establish pressure threshold levels.

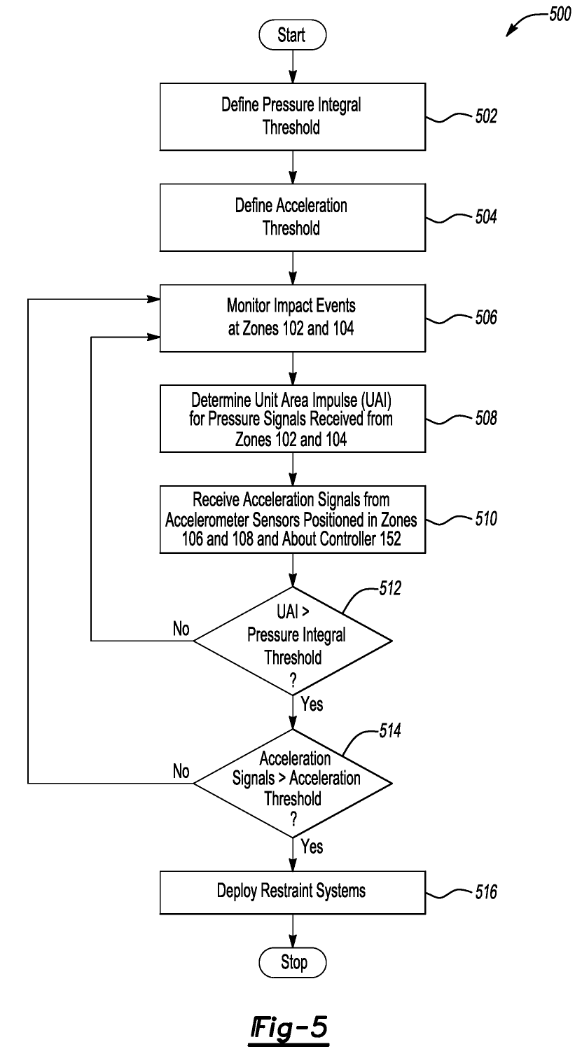

To obviate such a condition from occurring, the controller 152 may integrate the pressure readings received by the pressure sensors 154 to clearly separate restraint system deploy and non-deploy events during a side impact condition as detailed in FIGS. 4-5

FIG. 4 illustrates a third plot 400 depicting time with respect to pressure integral signals (e.g., pressure signals integrated by the controller 152) for a low intensity level side impact. The integration of the pressure readings will be discussed in more detail in connection with FIG. 5. Waveform 402 corresponds to pressure integral signals that may be exhibited with respect to time while the vehicle 100 undergoes the 12 mph (PP) vehicle side impact test. Waveform 404 corresponds to pressure integral signals that may be exhibited with respect to time while the vehicle 100 undergoes a 12 mph Cart test. Again, the 12 mph Cart test is a non-deploy test. Line 406 corresponds to a pressure integral level threshold that may be defined and stored in the controller 152. As shown in FIG. 4, there is no overlap between the pressure integral values of the waveform 402 and of the waveform 404. The controller 152 may distinguish between a low intensity level side impact deploy event and a low intensity level side impact non-deploy event in response to integrating the pressure signals received from the pressure sensors 154.

The pressure integral level threshold selected to separate low intensity impact deploy and non-deploy events also covers restraint system deploy requirements for medium and high intensity level side impact events. Further, the controller 152 may integrate pressure signals received from pressure sensors positioned in zones 106 and 108 and/or from pressure sensors positioned in the front and/or rear of the vehicle 100. As such, the integrated pressure signals received from pressure sensors positioned from those corresponding areas may be used to determine deployable or non-deployable events at the zones 106 and/or 108 and/or at the front and/or rear of the vehicle 100.

Referring now to FIG. 5, a method 500 for sensing side impacts of the vehicle 100 in accordance to one embodiment of the present invention is shown. The controller 152 includes logic (software or hardware or combination thereof) for executing operations of the method 50. The operations as described below may be performed sequentially or non-sequentially. Further, such operations are capable of being performed simultaneously or serially with respect to one another. The particular order and execution times of the operations set forth below may vary based on the desired criteria of a particular implementation.

In operation 502, the controller 152 stores the pressure integral level threshold corresponding to a side impact level. In operation 504, the controller 152 stores acceleration thresholds that may be used for comparison to received acceleration signals for deployment validation purposes.

In operation 506, the controller 152 receives the pressure signals from the pressure sensors 154 positioned in zones 102 and 104.

In operation 508, the controller 152 determines the unit area impulse (UAI) for the measured pressure readings received from the pressure sensors 154 to generate the integrated pressure signals. The following equation below may be used to determine the UAI:

UAI=∫ₜ₂^{t1}P·dt EQ.1

where P corresponds to the measure pressure readings (or signals), t1 and t2 corresponds to a moving window of time (e.g., 10 msec to 40 msec) (see FIG. 4) and UAI corresponds to an integrated value of P with a pre-defined time frame. It is generally contemplated that the values for the pre-defined time frame may vary based on the desired criteria of a particular application.

In operation 510, the controller 152 receives acceleration signals from the accelerometer sensors 156 positioned in zones 106 and 108 and from the accelerometer sensor 156′ positioned within or about the controller 152.

In operation 512, the controller 152 determines whether the integrated pressure signals are greater than the pressure integral level threshold. In the event the controller 152 determines that the integrated pressure signals are not greater than the pressure integral level threshold, the method 500 moves back to operation 506. In the event the controller 152 determines that the integrated pressure signals are greater than the pressure integral level threshold, the method 500 moves to operation 514.

In operation 514, the controller 152 compares the measured acceleration signals received from the accelerometer sensors 156 and 156′ to the acceleration thresholds. In the event the controller 152 determines that the acceleration signals are not greater than the acceleration thresholds, the method 500 moves back to operation 506. In the event the controller 152 determines that the acceleration signals are greater than the acceleration thresholds, the method 500 moves to operation 516.

In operation 516, the controller 152 deploys side impact restraint systems to protect occupants in the vehicle 100. Such restraint systems may include curtain, side airbags and/or deployable side bolsters or other suitable side impact protection systems.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the invention.

What is claimed:

1. A system for detecting impact events for a vehicle, the system comprising:
a pressure sensor positioned in a first impact zone of the vehicle, the at least one pressure sensor being configured to generate a pressure signal corresponding to a measured pressure reading within the first impact zone; and
a controller positioned within the vehicle and configured to integrate the pressure signal over time to determine the occurrence of a vehicle impact event at the first impact zone.

2. The system of claim 1 wherein the first impact zone of the vehicle corresponds to a side impact zone and the vehicle impact corresponds to a side impact event.

3. The system of claim 1 wherein the controller is further configured to generate an integrated pressure signal in response to integrating the pressure signal and to store a pressure integral level threshold for comparison to the integrated pressure signal.

4. The system of claim 3 further comprising:
a first accelerometer sensor positioned within a second impact zone and configured to generate a first acceleration signal corresponding to measured structural movement of a portion of the vehicle within the second impact zone; and
a second accelerometer sensor positioned within the controller or about a center of the vehicle to generate a second acceleration signal corresponding to measured structural movement about the center of the vehicle.

5. The system of claim 4 wherein the controller is configured to store at least one acceleration threshold for comparison to the first and the second acceleration signals.

6. The system of claim 5 wherein the controller is configured to deploy a restraint system to protect a vehicle occupant in response to determining that the integrated pressure signal exceeds the pressure integral level threshold and the first and the second acceleration signals exceed the at least one acceleration threshold.

7. The system of claim 6 wherein the restraint system corresponds to a least one of a curtain airbag, a side airbag and a deployable side bolster.

8. A method for detecting impact events for a vehicle, the method comprising:
positioning a pressure sensor in a first impact zone of the vehicle;
generating a pressure signal with the pressure sensor that corresponds to a measured pressure reading within the first impact zone; and
integrating the pressure signal over time to determine the occurrence of a vehicle impact event at the first impact zone of the vehicle.

9. The method of claim 8 wherein the first impact zone of the vehicle corresponds to a side impact zone and the vehicle impact corresponds to a side impact event.

10. The method of claim 8 further comprising generating an integrated pressure signal in response to integrating the pressure signal and storing a pressure integral level threshold for comparison to the integrated pressure signal.

11. The method of claim 10 further comprising
positioning a first accelerometer sensor in a second impact zone of the vehicle; and
generating a first acceleration signal with the accelerometer sensor corresponds to measured structural movement of a portion of the vehicle within the second impact zone.

12. The method of claim 11 further comprising
positioning a second accelerometer sensor within the controller or about a center of the vehicle; and
generating a second acceleration signal that corresponds to measured structural movement about the center of the vehicle.

13. The method of claim 12 further comprising storing at least one acceleration threshold for comparison to the first and the second acceleration signals.

14. The method of claim 13 further comprising deploying a restraint system to protect a vehicle occupant in response to determining that that integrated pressure signal exceeds the pressure integral level threshold and the first and the second acceleration signals exceed the at least one acceleration threshold.

15. The method of claim 14 wherein the restraint system corresponds to at least one of a curtain airbag, a side airbag and a deployable side bolster.

16. A system for detecting side impact events for a vehicle, the system comprising:
a first pressure sensor positioned about a front driver side of the vehicle, the first pressure sensor being configured to generate a first pressure signal corresponding to a measured pressure reading within the front driver side of the vehicle;
a second pressure sensor positioned about a front-passenger side of the vehicle, the second pressure sensor being configured to generate a second pressure signal corresponding to a measured pressure reading within the front passenger side of the vehicle; and
a controller positioned within the vehicle and configured to integrate the first and the second pressure signals over time to generate first and second integrated pressure signals, respectively, and to determine the occurrence of a vehicle side impact event at one or more the front driver side and the front passenger side of the vehicle based on the first and the second integrated pressure signals.

17. The system of claim 16 wherein the controller is further configured to store at least one pressure integral level threshold for comparison to the first and the second integrated pressure signals.

18. The system of claim 17 further comprising:
a first accelerometer sensor positioned within a second impact zone and configured to generate a first acceleration signal corresponding to measured structural movement of a portion of the vehicle within the second impact zone, and
a second accelerometer sensor positioned about the center of the vehicle to generate a second acceleration signal corresponding to measured structural movement about the center of the vehicle.

19. The system of claim 18 wherein the controller is further configured to store at least one acceleration threshold for comparison to the first and the second acceleration signals.

20. The system of claim 19 wherein the controller is further configured to deploy a restraint system to protect a vehicle occupant in response to determining that the at least one of the first and the second acceleration signals exceeds the at least one acceleration threshold and the at least one of the first and the second integrated pressure signals exceed the at least one pressure integral level threshold.
